(19) United States
(12) Patent Application Publication
(10) Pub. No.: US 2015/0312675 A1
(43) Pub. Date: Oct. 29, 2015

(54) COMPUTER HAVING AUDIO PROCESSING OPERATION

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: WEI ZHANG, Shenzhen (CN); JIAN-PING DENG, Shenzhen (CN); YA-FANG DING, Shenzhen (CN); HAI LIU, Shenzhen (CN)

(21) Appl. No.: 14/695,058

(22) Filed: Apr. 24, 2015

(30) Foreign Application Priority Data
Apr. 24, 2014 (CN) 201410166189.1

(51) Int. Cl. H04R 3/00; G06F 13/40

(52) U.S. Cl. CPC H04R 3/00; G06F 13/4068

(57) ABSTRACT

A computer includes a digital signal processor chip. The digital signal processor chip is configured to perform an optimization and/or a sound effect operation on an audio signal. Additionally, the digital signal processor may not perform the operation on the audio signal when the earphone is not couple to a jack.

### FIELD

The subject matter herein generally relates to an audio processing system for a computer.

### BACKGROUND

On plugging into a jack in a motherboard, a high-class earphone can generate a better sound effect than a common earphone, owing to additional optimization operations having performed on the received audio signal from the jack by itself.

### BRIEF DESCRIPTION OF THE DRAWINGS

Implementations of the present technology will now be described, by way of example only, with reference to the attached figures.

FIG. 1 is a block diagram of a motherboard of the present disclosure.

FIG. 2 is a block diagram of a computer of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The present disclosure is described in relation to a computer with a motherboard providing better user experience in spite of kinds of audio producing device.

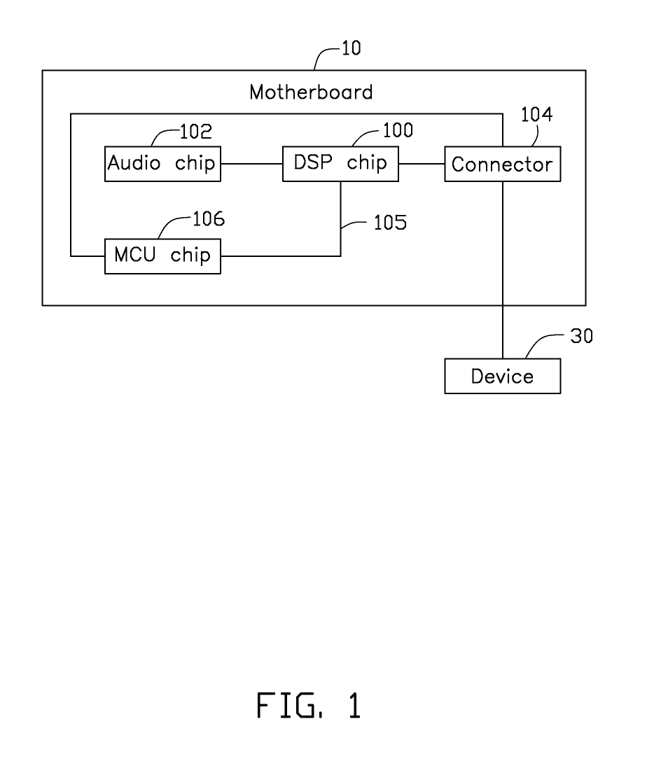

FIG. 1 illustrates a motherboard 10 of the present disclosure. The motherboard 10 can comprise a connector 104 having different states, an audio chip 102 outputting a first audio signal, a micro controller unit (MCU) chip 106 coupled to the connector 104 to output a control signal according to a predetermined state of the connector 104, a digital signal processor (DSP) chip 100 performing an optimization operation on the first audio signal as receiving the control signal from the MCU chip 106. The DSP chip 100 can further output a second audio signal to the connector 104 after performing the optimization operation on the first audio signal.

In one embodiment, the connector 104 can have a first state and a second state. The connector 104 can be at the first state when an audio producing device 30 (e.g. an earphone) is plugged into the connector 104. Alternatively, the connector 104 can be at the second state when the connector 104 has no device to be connected. In one embodiment, the connector 104 can output a first connection signal (e.g. a low-voltage level signal) when the connector 104 is at the first state, the connector 104 can output a second connection signal (e.g. a high-voltage level signal) when the connector 104 is at the second state.

The MCU chip 106 is configured to receive the first connection signal or the second connection signal, and can output a corresponding control signal to the DSP chip 100 through a bus 105. For example, the MCU chip 106 can output a first control signal when the first connection signal is received from the connector 104, the MCU chip 106 can output a second control signal when the second connection signal is received from the connector 104. In an illustrated embodiment, the MCU chip 106 can output the first control signal or the second control signal to the DSP chip 100 through an inter-integrated circuit (I2C) bus or a system management bus (SMBus).

The DSP chip 100 can receive the first audio signal, and perform the optimization operation on the first audio signal, to generate the second audio signal. The device 30 can receive the second audio signal from the connector 104. In one embodiment, the first audio signal may not be converted to the second audio signal when the DSP chip 100 receives the second control signal.

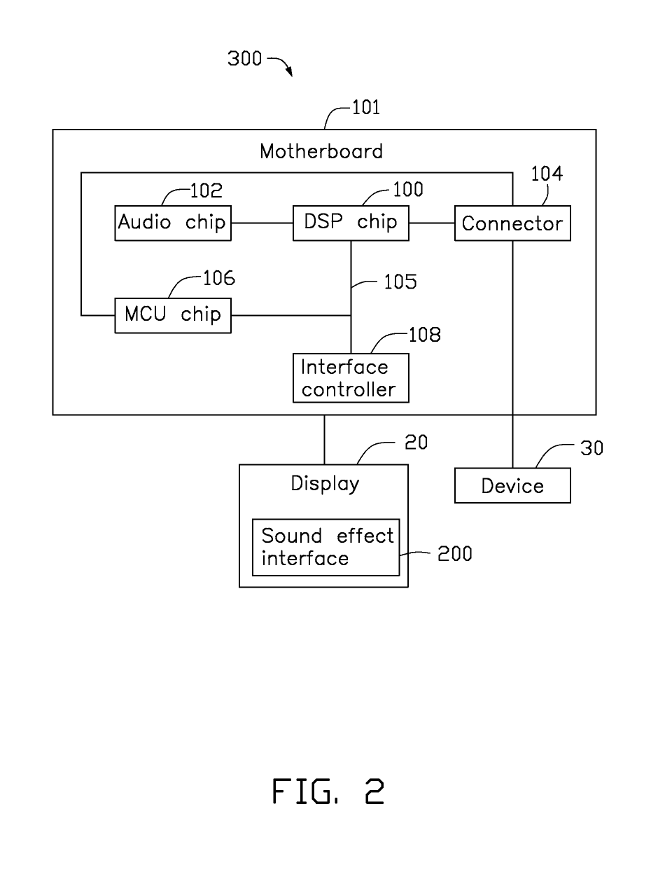

FIG. 2 illustrates a computer 300. The computer 300 can comprise a motherboard 101 and a display 20 coupled to the motherboard 101. The motherboard 101 can comprise the connector 104, the audio chip 102, the MCU chip 106, and the DSP chip 100 of the motherboard 10. As comparing to the motherboard 10, the motherboard 101 can further comprise an interface controller 108 coupled to the MCU chip 106 and the DSP chip 100 through the bus 105. The MCU chip 106 can further generate a sound effect interface 200 on the display 20, allowing a user to determine which sound effect is applied to the first audio signal. In one embodiment, the sound effect interface 200 can comprise sound effects of classic, pop, and country etc.. The interface controller 108 further output a selection signal to the DSP chip 100 according to user's operation on the sound effect interface 200. The DSP chip 100 can perform a sound effect operation on the first audio signal to output a third audio signal to the connector 104.

In one embodiment, the interface controller 108 can further output the selection signal to the MCU chip 106. The MCU chip 106 can suspend the communication between the MCU chip 106 and the DSP chip 100 for a certain time when the interface controller 108 outputs the selection signal to the DSP chip 100. The DSP chip 100 can store a last state of the control signal before the communication between the MCU chip 106 and the DSP chip 100 resumed.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A motherboard, comprising:
a connector configured for outputting a first connection signal;
a micro controller unit (MCU) chip outputting a first control signal in response to receiving the first connection signal from the connector;
an audio chip outputting a first audio signal; and
a digital signal processor (DSP) chip performing an optimization operation on the first audio signal to generate a second audio signal in response to receiving the first connection signal, and outputting the second signal to the connector.

2. The motherboard of claim 1, wherein the first connection signal is a low-level voltage signal.

3. The motherboard of claim 1, wherein the connector is further configured to output a second connection signal, the MCU chip receives the second connection signal and outputs the second control signal to the DSP chip, the DSP chip performs no operation on the first audio signal in response to receiving the second control signal.

4. The motherboard of claim 3, wherein the second connection signal is a high-level voltage signal.

5. The motherboard of claim 3, wherein the MCU chip communicates with the DSP chip through an inter-integrated circuit bus.

6. The motherboard of claim 3, wherein the MCU chip communicates with the DSP chip through a system management bus.

7. A computer, comprising:
a motherboard, comprising:
a connector outputting a first connection signal on condition that coupling to an audio producing device;
a micro controller unit (MCU) chip outputting a first control signal in response to receiving the first connection signal from the connector;
an audio chip outputting a first audio signal;
a digital signal process (DSP) chip receiving the first control signal from the MCU chip; and
a interface controller coupled to the DSP chip and the MCU chip; and
a display coupled to the interface controller of the motherboard;
wherein the MCU chip is configured to produce a sound effect interface on the display through the interface controller, the interface controller outputs a selection signal to the DSP chip according to an input on the sound effect interface, the DSP chip performs a sound effect operation on the first audio signal to generate a second audio signal, and outputs the second audio signal to the connector.

8. The computer of claim 7, wherein the interface controller further outputs the selection signal to the MCU chip, the MCU chip suspends the communication between the MCU chip and the DSP chip when the MCU chip receives the selection signal.

9. The computer of claim 8, wherein the DSP chip stores a last state of the control signal from the MCU chip before the communication between the MCU chip and DSP chip resumed.

10. The computer of claim 7, wherein the first connection signal is a low-level voltage signal.

11. The computer of claim 7, wherein when no device is coupled to the connector, the connector outputs a second connection signal, the MCU chip receives the second connection signal and outputs a second control signal to the DSP chip, the DSP chip performs no operation on the first audio signal in response to receiving the second control signal.

12. The computer of claim 11, wherein the second connection signal is a high-level voltage signal.

13. The computer of claim 7, wherein the MCU chip communicates with the DSP chip through an inter-integrated circuit bus.

14. The computer of claim 7, wherein the MCU chip communicates with the DSP chip through a system management bus.
